(19) United States
(12) Patent Application Publication
(10) Pub. No.: US 2026/0310787 A1
(43) Pub. Date: Oct. 8, 2026

(54) QUANTUM RESISTANT TRUST ORCHESTRATION FOR BRAIN COMPUTER INTERFACES

(71) Applicant: George William Bickerstaff, III, Greenwich, CT (US)

(72) Inventor: George William Bickerstaff, III, Greenwich, CT (US)

(21) Appl. No.: 19/453,312

(22) Filed: Jan. 20, 2026

(51) Int. Cl. G06F 21/56

(52) U.S. Cl. CPC G06F 21/568; G06F 2221/034

(57) ABSTRACT

A quantum-resistant trust orchestration system for brain-computer interfaces assigns trust-weighted authority to neural interpretations, correlates outcomes to neural intent, and enables automated rollback. The system generates immutable governance records suitable for medical, regulatory, and cross-domain deployment of brain-computer interface systems.

### TECHNICAL FIELD

The present invention relates to neurotechnology, artificial intelligence governance, and secure data orchestration and, more particularly, to systems and methods for quantum-resistant trust management, accountability, and safety enforcement in brain-computer interface systems.

### BACKGROUND

Brain-computer interfaces enable direct communication between neural signals and computational systems, allowing neural activity to initiate, modify, or control digital and physical processes.

As brain-computer interfaces increasingly rely on artificial intelligence for signal interpretation, decision-making, and actuation, risks arise related to privacy, cognitive safety, unauthorized use, and attribution of responsibility for AI-mediated actions.

Existing brain-computer interface architectures focus primarily on signal acquisition, decoding accuracy, and hardware performance, but lack deterministic mechanisms for trust verification, outcome attribution, rollback, and governance of AI-driven neural interpretations.

The absence of machine-verifiable trust and accountability frameworks creates regulatory uncertainty, ethical risk, and barriers to large-scale deployment of brain-computer interfaces in medical, financial, robotic, and human-AI hybrid environments.

### SUMMARY OF THE INVENTION

The invention provides a quantum-resistant trust orchestration system for brain-computer interfaces that assigns dynamic trust states to neural data, AI interpretations, and downstream actions.

The system captures neural intent, execution context, and authorization prior to action execution, correlates these inputs with observed outcomes, and generates immutable governance records.

By embedding trust scoring, zero-knowledge verification, and automated rollback directly into brain-computer interface workflows, the invention enables safe, auditable, and regulator-grade deployment of neurotechnology systems.

### DEFINITIONS (ALPHABETICAL)

Action Outcome: A measurable result produced by execution of a brain-computer interface-mediated action.
Authorization State: A permission status governing allowable use of neural data or actions. [0011] Brain-Computer Interface (BCI): A system enabling communication between neural signals and computational processes. [0012] Cognitive Safety Threshold: A defined boundary beyond which neural interpretation may pose risk to a user. [0013] Execution Context: Conditions and system states present during neural data interpretation or action execution.
Governance Ledger: An immutable, cryptographically protected record of trust and accountability events. [0015] Neural Intent Record: A representation of purpose inferred from neural signals or user context. [0016] Quantum-Resistant Provenance: Cryptographic records designed to remain secure against quantum computing attacks. [0017] Rollback State: A previously validated configuration used to restore safe system operation. [0018] Trust Score: A quantified confidence metric assigned to neural data, interpretations, or actions.

### BRIEF DESCRIPTION OF THE DRAWINGS

FIG. 1 illustrates neural intent capture and authorization.

FIG. 2 illustrates neural execution monitoring and outcome correlation. [0021] FIG. 3 illustrates trust scoring and attribution processing. [0022] FIG. 4 illustrates automated rollback and cognitive safety enforcement. [0023] FIG. 5 illustrates cross-domain interoperability and regulatory integration.

### DETAILED DESCRIPTION OF THE INVENTION

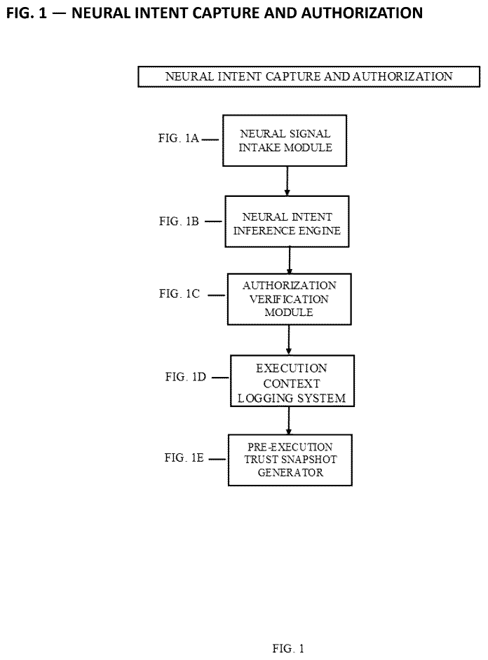

### FIG. 1—Neural Intent Capture and Authorization

FIG. 1A illustrates a neural signal intake module receiving raw neural data from a brain-computer interface device. Signals are time-stamped and normalized. Data integrity checks are performed.

FIG. 1B illustrates a neural intent inference engine that derives a neural intent record from signal patterns and contextual inputs. The inferred intent is probabilistic and confidence-scored. Intent records are versioned.

FIG. 1C illustrates an authorization verification module that determines whether inferred intent may trigger downstream actions. Authorization may depend on medical approval, user consent, or policy constraints. Unauthorized intents are blocked.

FIG. 1D illustrates an execution context logger recording device state, model version, and environmental conditions. Context is synchronized with neural data. This preserves execution conditions.

FIG. 1E illustrates a pre-execution trust snapshot aggregating intent, authorization, and context into an immutable governance record. The snapshot is sealed prior to execution. Execution proceeds conditionally.

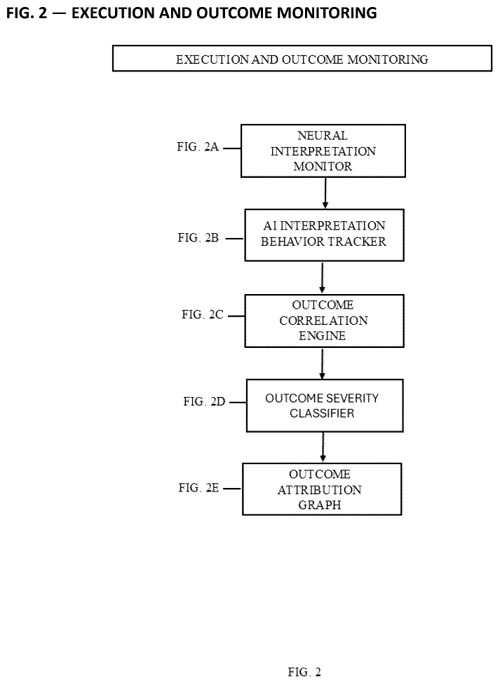

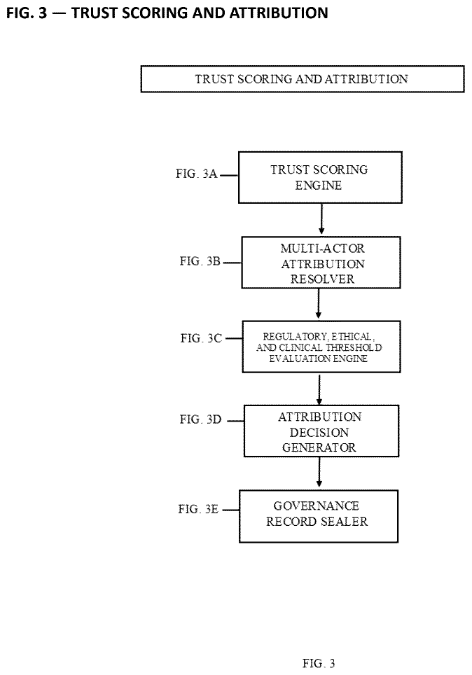

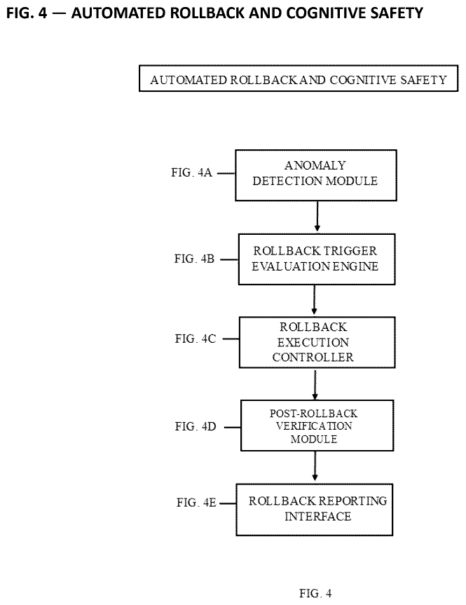

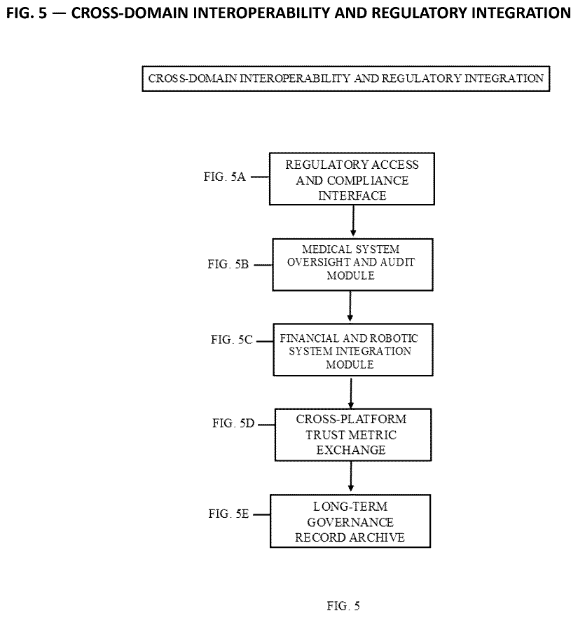

### FIG. 2—Execution and Outcome Monitoring

FIG. 2A illustrates a neural interpretation monitor observing decoding accuracy and confidence drift. Anomalies are detected in real time. Monitoring persists throughout execution.

FIG. 2B illustrates an AI behavior tracker evaluating whether neural interpretations remain within approved cognitive safety thresholds. Deviations are quantitatively scored. Trust scores are updated dynamically.

FIG. 2C illustrates an outcome correlation engine mapping executed actions to neural intent records and model states. Correlation is deterministic. This enables explainable attribution.

FIG. 2D illustrates an outcome severity classifier evaluating whether observed effects exceed safety, ethical, or regulatory limits. Severity determines escalation or rollback. Classification is logged immutably.

FIG. 2E illustrates an outcome attribution graph linking neural signals, AI interpretations, and resulting actions. The graph supports root-cause analysis. Records are preserved.

### FIG. 3—Trust Scoring and Attribution

FIG. 3A illustrates a trust scoring engine computing confidence values using historical performance, neural signal consistency, and corroborating inputs. Scores evolve over time. Persistent degradation reduces system autonomy.

FIG. 3B illustrates a multi-actor attribution resolver allocating responsibility among users, AI models, and system operators. Allocation reflects degree of influence and authorization. Shared responsibility is quantified.

FIG. 3C illustrates threshold evaluation against regulatory, ethical, and clinical criteria. Threshold violations generate compliance events. Events are auditable.

FIG. 3D illustrates attribution decision generation producing machine-readable determinations with supporting rationale. Determinations are reproducible. Records are sealed.

FIG. 3E illustrates a governance record sealer cryptographically protecting attribution outcomes. Records are time-stamped and tamper-evident. Long-term integrity is preserved.

### FIG. 4—Automated Rollback and Cognitive Safety

FIG. 4A illustrates anomaly detection identifying unsafe neural interpretation patterns. Detection uses absolute and trend-based thresholds. Alerts propagate immediately.

FIG. 4B illustrates rollback trigger evaluation comparing trust degradation and cognitive safety thresholds. Rollback criteria are deterministic and policy-approved. Human intervention is optional.

FIG. 4C illustrates rollback execution restoring a validated prior configuration. Restoration includes decoding parameters and authorization states. Latency is minimized.

FIG. 4D illustrates post-rollback verification confirming cognitive safety and compliance. Verification outcomes update trust models. Results are sealed.

FIG. 4E illustrates standardized rollback reporting to clinicians, regulators, and system operators. Reports include causality and response metrics. Transmission is secure.

### FIG. 5—Cross-Domain Integration

FIG. 5A illustrates a regulatory interface providing authorized access to governance records. Interfaces support jurisdiction-specific workflows. Access is logged.

FIG. 5B illustrates medical system integration enabling clinician oversight and auditability. Trust states inform treatment decisions. Privacy is preserved.

FIG. 5C illustrates financial and robotic system integration enabling hybrid human-AI actions. Authorization states propagate across domains. Trust enforcement is consistent.

FIG. 5D illustrates cross-platform interoperability using trust metrics rather than raw neural data. Proprietary information is protected. Governance consistency is maintained.

FIG. 5E illustrates long-term archival for regulatory and legal purposes. Retention policies comply with jurisdictional requirements. Retrieval is auditable.

### Example Embodiments

Example Embodiment I: A medical brain-computer interface interprets neural intent to control a prosthetic device. Trust scoring detects confidence degradation and triggers rollback to a clinician-approved configuration. The event is immutably recorded.
Example Embodiment II: A consumer brain-computer interface interfaces with a robotic system. Anomalous neural patterns exceed cognitive safety thresholds, triggering automated rollback prior to unsafe actuation. User safety and compliance are preserved without human intervention.

1. A quantum-resistant trust orchestration system for brain-computer interfaces, comprising:
a neural intent capture engine configured to generate a neural intent record;
a trust scoring engine configured to assign confidence values to neural interpretations;
an outcome attribution module configured to correlate executed actions to neural intent records; and
a rollback controller configured to restore a validated prior operational state based on trust degradation or cognitive safety thresholds.

2. A method for governing brain-computer interface actions, comprising:
capturing neural intent and execution context prior to execution;
executing an action based on a trust score;
monitoring outcomes and cognitive safety;
attributing outcomes to neural intent; and
recording a governance record in an immutable ledger.

3. A non-transitory computer-readable medium storing instructions that, when executed by a processor, cause the processor to implement trust attribution and automated rollback for brain-computer interface systems.

4. The system of claim 1, wherein the trust score evolves based on historical neural interpretation outcomes.

5. The method of claim 2, wherein rollback is triggered automatically upon trust score degradation.

6. The system of claim 1, further comprising a regulatory reporting interface.

7. The method of claim 2, wherein outcome attribution is multi-actor based.

8. The system of claim 1, wherein provenance records are quantum-resistant.

9. The computer-readable medium of claim 3, wherein governance records are immutable.

10. The system of claim 1, wherein authorization states are enforced across multiple domains.
